(19) United States
(12) Patent Application Publication
(10) Pub. No.: US 2012/0053714 A1
(43) Pub. Date: Mar. 1, 2012

(54) SIGNAL DELAY DETECTION METHOD, DETECTION APPARATUS, CODER

(75) Inventors: Wenhai Wu, Beijing (CN); Lei Miao, Beijing (CN); Yue Lang, Munich (DE); Chen Hu, Shenzhen (CN); Zexin Liu, Beijing (CN); Qing Zhang, Shenzhen (CN)

(73) Assignee: Huawei Technologies Co., Ltd., Shenzhen (CN)

(21) Appl. No.: 13/290,809

(22) Filed: Nov. 7, 2011

Related U.S. Application Data
(63) Continuation of application No. PCT/CN2009/071669, filed on May 7, 2009.

(51) Int. Cl. G06F 17/00

(52) U.S. Cl. 700/94

(57) ABSTRACT

A signal delay detection method, a detection apparatus, and a coder are disclosed to improve accuracy of detecting the signal delay. The method includes: obtaining a first cumulative cross-correlation function according to cross-correlation functions between channel signals; determining a first delay between the channel signals corresponding to the first cumulative cross-correlation function; adjusting a second cumulative cross-correlation function according to a relationship between the first delay and a second delay that exist between the channel signals, where the second delay is obtained at time of adjusting the second cumulative cross-correlation function and an initial value of the second delay is determined according to an initial value of a second weighting coefficient of the second cumulative cross-correlation function; and determining the second delay corresponding to the adjusted second cumulative cross-correlation function as a delay detected between the channel signals.

### CROSS-REFERENCE TO RELATED APPLICATIONS

This application is a continuation of International Application No. PCT/CN2009/071669, filed on May 7, 2009, which is hereby incorporated by reference in its entirety.

### TECHNICAL FIELD

The present invention relates to signal processing technologies, and in particular, to a signal delay detection method, a detection apparatus, and a coder.

### BACKGROUND

With development of computer technologies and digital signal processing technologies, stereo technologies are developing rapidly. A commonly used stereo coding method in the stereo technologies of the prior art is parametric stereo coding.

In the parametric stereo coding, the left-channel signal and the right-channel signal are mixed down, and then the mixed signals are encoded. Generally, a delay exists between the left-channel signal and the right-channel signal. Therefore, the delay between the left-channel signal and the right-channel signal is correctly detected, and the signals are synchronized according to the delay, so as to improve the quality of the stereo mixed signals. A signal delay detection method provided in the prior art is: Suppose that the signal delay is positive when the left-channel signal comes before the right-channel signal, and is negative when the left-channel signal comes after the right-channel signal; before the left-channel signal is mixed down with the right-channel signal, obtain a cross-correlation function of the left-channel signal and the right-channel signal, and determine a cumulative cross-correlation function of the cross-correlation function; determine the maximum value of the cumulative cross-correlation function, and use the time corresponding to the maximum value as the delay between the left-channel signal and the right-channel signal.

In the research and practice process of the foregoing method, the inventor of the present invention finds that:

When the sound field of the left-channel signal and the right-channel signal changes, namely, switches from one direction to another direction, the signal delay changes from a positive value to a negative value or vice versa, but the cumulative cross-correlation function in the prior art cannot reflect the change, which leads to inaccuracy of the detected signal delay.

### SUMMARY

The embodiments of the present invention provide a signal delay detection method, a detection apparatus, and a coder to improve accuracy of detecting the signal delay.

A signal delay detection method includes:

obtaining a first cumulative cross-correlation function according to cross-correlation functions between channel signals;

determining a first delay between the channel signals corresponding to the first cumulative cross-correlation function;

adjusting a second cumulative cross-correlation function according to a relationship between the first delay and a second delay that exist between the channel signals, where the second delay is obtained at time of adjusting the second cumulative cross-correlation function and an initial value of the second delay is determined according to an initial value of a second weighting coefficient of the second cumulative cross-correlation function; and determining the second delay corresponding to the adjusted second cumulative cross-correlation function as a delay detected between the channel signals.

A detection apparatus includes:

an obtaining unit, configured to obtain a first cumulative cross-correlation function according to cross-correlation functions between channel signals;

a first delay processing unit, configured to determine a first delay between the channel signals corresponding to the first cumulative cross-correlation function;

an adjusting unit, configured to adjust a second cumulative cross-correlation function according to a relationship between the first delay and a second delay that exist between the channel signals, where the second delay is obtained at time of adjusting the second cumulative cross-correlation function and an initial value of the second delay is determined according to an initial value of a second weighting coefficient of the second cumulative cross-correlation function; and

a second delay processing unit, configured to determine the second delay corresponding to the adjusted second cumulative cross-correlation function as a delay detected between the channel signals.

A coder includes:

a signal obtaining apparatus, configured to obtain channel signals; and

a detection apparatus, configured to: obtain a first cumulative cross-correlation function according to cross-correlation functions between channel signals; determine a first delay between the channel signals corresponding to the first cumulative cross-correlation function; adjust a second cumulative cross-correlation function according to a relationship between the first delay and a second delay that exist between the channel signals, where the second delay is obtained at time of adjusting the second cumulative cross-correlation function and an initial value of the second delay is determined according to an initial value of a second weighting coefficient of the second cumulative cross-correlation function; and determine the second delay corresponding to the adjusted second cumulative cross-correlation function as a delay detected between the channel signals.

In the technical solutions of the embodiments of the present invention, the first cumulative cross-correlation function is obtained according to cross-correlation functions between channel signals; the first delay between the channel signals corresponding to the first cumulative cross-correlation function is determined; the second cumulative cross-correlation function is adjusted according to the relationship between the first delay and the second delay that exist between the channel signals, where the second delay is obtained at the time of adjusting the second cumulative cross-correlation function and the initial value of the second delay is determined according to the initial value of the second weighting coefficient of the second cumulative cross-correlation function; and the second delay is determined as a delay detected between the channel signals. The determined delay can reflect whether the delay between the channel signals changes from a positive value to a negative value or vice versa, and improves accuracy of the detected signal delay.

### BRIEF DESCRIPTION OF THE DRAWINGS

To illustrate the technical solutions of the present invention or in the prior art more clearly, the following outlines the accompanying drawings involved in description of the embodiments of the present invention or the prior art. Apparently, the accompanying drawings outlined below are illustrative rather than exhaustive, and persons of ordinary skill in the art can derive other drawings from the accompanying drawings without any creative effort.

FIG. 1 is a flow chart of a method for detecting a signal delay according to a first embodiment of the present invention;

FIG. 2 is a flow chart of a method for detecting a signal delay according to a second embodiment of the present invention;

FIG. 3 is a flow chart of adjusting a weighting coefficient α2 according to a second embodiment of the present invention;

FIG. 4 is a schematic diagram of a signal trace waveform for detecting a signal delay according to a second embodiment of the present invention;

FIG. 5 is a flow chart of a method for detecting a signal delay according to a third embodiment of the present invention;

FIG. 6 is a flow chart of adjusting a weighting coefficient α2 according to a third embodiment of the present invention;

FIG. 7 is a flow chart of a method for detecting a signal delay according to a fourth embodiment of the present invention;

FIG. 8 is a flow chart of detecting effectiveness of change of a delay between different channel signals according to a fourth embodiment of the present invention;

FIG. 9 is a schematic diagram of a signal trace waveform for detecting effectiveness of delay change according to a fourth embodiment of the present invention;

FIG. 10 is a schematic diagram of a first structure of a detection apparatus according to an embodiment of the present invention;

FIG. 11 is a schematic diagram of a second structure of a detection apparatus according to an embodiment of the present invention; and

FIG. 12 is a schematic diagram of a structure of a coder according to an embodiment of the present invention.

### DETAILED DESCRIPTION

The technical solutions of the embodiments of the present invention are clearly and completely described in conjunction with the accompanying drawings. Evidently, the described embodiments are merely part of rather than all of embodiments. All other embodiments, which can be derived by those skilled in the art from the embodiments given herein without any creative effort, shall fall within the protection scope of the present invention.

The embodiments of the present invention provide a signal delay detection method, a detection apparatus, and a coder to improve accuracy of detecting the signal delay.

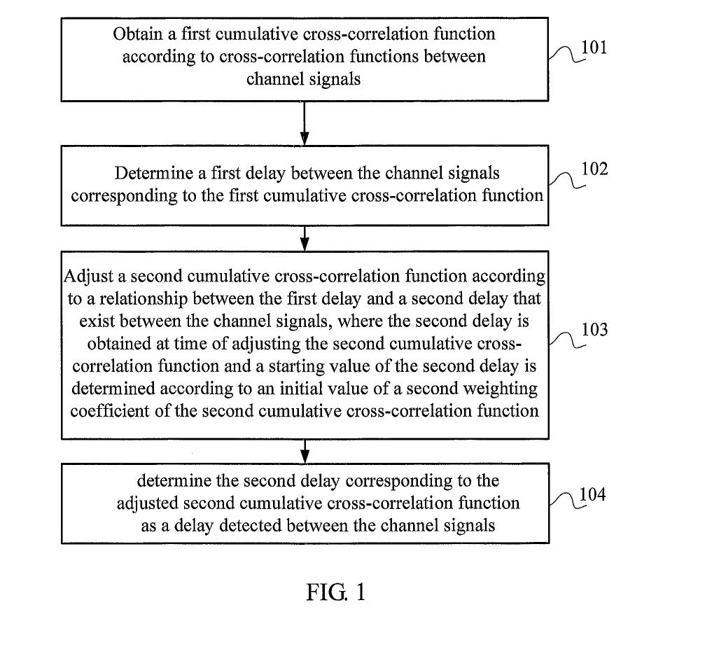

FIG. 1 is a flow chart of a method for detecting a signal delay according to a first embodiment of the present invention. The method includes the following steps:

Step 101: Obtain a first cumulative cross-correlation function according to cross-correlation functions between channel signals.

Step 102: Determine a first delay between the channel signals corresponding to the first cumulative cross-correlation function.

Step 103: Adjust a second cumulative cross-correlation function according to a relationship between the first delay and a second delay that exist between the channel signals, where the second delay is obtained at time of adjusting the second cumulative cross-correlation function and an initial value of the second delay is determined according to an initial value of a second weighting coefficient of the second cumulative cross-correlation function.

Step 104: Determine the second delay corresponding to the adjusted second cumulative cross-correlation function as a delay detected between the channel signals.

The step of adjusting the second cumulative cross-correlation function according to the relationship between the first delay and the second delay that exist between the channel signals includes: obtaining an initial value of the second weighting coefficient of the second cumulative cross-correlation function; if determining that the first delay is not equal to the second delay, decreasing the initial value of the second weighting coefficient to obtain a decreased value; and updating the second cumulative cross-correlation function according to the decreased value of the second weighting coefficient.

Alternatively, the step of adjusting the second cumulative cross-correlation function according to the relationship between the first delay and the second delay that exist between the channel signals includes: setting a value of the second weighting coefficient of the second cumulative cross-correlation function according to sound field information of the first cumulative cross-correlation function; if determining that the first delay is not equal to the second delay, decreasing the set value of the second weighting coefficient to obtain a decreased value.

The first cumulative cross-correlation function may be a short-time cumulative cross-correlation function, and the second cumulative cross-correlation function may be a long-time cumulative cross-correlation function.

In the first embodiment of the present invention, the first cumulative cross-correlation function is obtained according to cross-correlation functions between channel signals; the first delay between the channel signals corresponding to the first cumulative cross-correlation function is determined; the second cumulative cross-correlation function is adjusted according to the relationship between the first delay and the second delay that exist between the channel signals, where the second delay is obtained at the time of adjusting the second cumulative cross-correlation function and the initial value of the second delay is determined according to the initial value of the second weighting coefficient of the second cumulative cross-correlation function; and the second delay is determined as a delay detected between the channel signals. The determined delay may reflect whether the delay between the channel signals changes from a positive value to a negative value or vice versa, and improves accuracy of the detected signal delay.

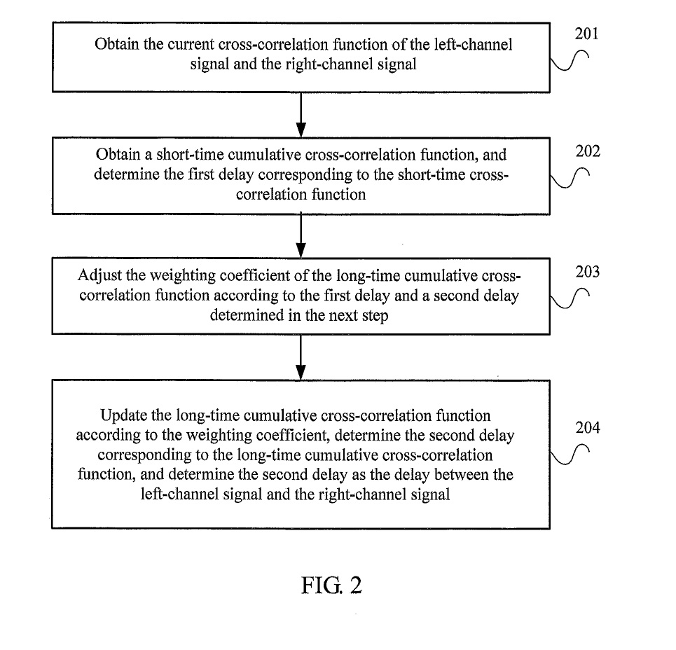

FIG. 2 is a flow chart of a method for detecting a signal delay according to a second embodiment of the present invention. Compared with the first embodiment, the second embodiment gives more details about the method disclosed herein. As shown in FIG. 2, the method includes the following steps:

Step 201: Obtain the current cross-correlation function of a left-channel signal and a right-channel signal.

The cross-correlation function of the left-channel signal and the right-channel signal is ccf(d), which may be calculated through the following formula (1):

$$ccf ( d ) = {\sum }_{n = 0}^{N - 1} l ( n ) * r ( n - d ) / sqrt ( {\sum }_{n = 0}^{N - 1} l ( n ) * l ( n ) * {\sum }_{n = 0}^{N - 1} r ( n - d ) * r ( n - d ) ) \qquad Formula ( 1 )$$

In formula (1), d is a constant and represents delay, n is a variable and represents the number of sample points of a signal frame, N is a natural number, r represents right-channel signal, and l represents left-channel signal.

It should be noted that formula (1) above is only an exemplary mode of calculating the cross-correlation function ccf(d), and the mode of calculating the function is not limited herein. Another mode of calculating this function is formula (2):

$$\begin{matrix} If ( {\sum }_{n = 0}^{N - 1} l ( n ) * r ( n - d ) > 0 ) , then & Formula ( 2 ) \\ ccf ( d ) = {( {\sum }_{n = 0}^{N - 1} l ( n ) * r ( n - d ) )}^{2} / ( {\sum }_{n = 0}^{N - 1} l ( n ) * l ( n ) * {\sum }_{n = 0}^{N - 1} r ( n - d ) * r ( n - d ) ) & \\ If ( {\sum }_{n = 0}^{N - 1} l ( n ) * r ( n - d ) <= 0 ) , then & \\ ccf ( d ) = 0 ) & \end{matrix}$$

The meanings of the letters in the formulae are the same as what described above.

Step 202: Obtain a short-time cumulative cross-correlation function, and determine a first delay corresponding to the short-time cross-correlation function.

The cumulative cross-correlation function is an MA function. Suppose that the cumulative cross-correlation function is a_ccf(d), and the weighting coefficient is α. a_ccf(d) may be calculated through the following formula (3):

a_ccf(d)=a_ccf(d)*α+ccf (d)α≧0 Formula (3)

The cumulative cross-correlation function may be further categorized into short-time cumulative cross-correlation function and long-time cumulative cross-correlation function. The short-time cumulative cross-correlation function and the long-time cumulative cross-correlation function are relative concepts. Suppose that the short-time cumulative cross-correlation function is s_ccf(d) and the weighting coefficient α is α1; the long-time cumulative cross-correlation function is l_ccf(d), and the weighting coefficient is α is α2, where 1≧α2>α1>0.

s_ccf(d)=s_ccf(d)*α1+ccf(d)

l_ccf(d)=l_ccf(d)*α2+ccf(d)

Different values of the short-time cumulative cross-correlation function are calculated according to the short-time cumulative cross-correlation function, where the weighting coefficient α1 can be an empiric value. The greatest value or the greatest but one is selected among such values, and the time corresponding to the selected value is determined as a first delay of the short-time cumulative cross-correlation function.

Step 203: Adjust the weighting coefficient α2 of the long-time cumulative cross-correlation function according to the first delay and a second delay that is determined in the next step.

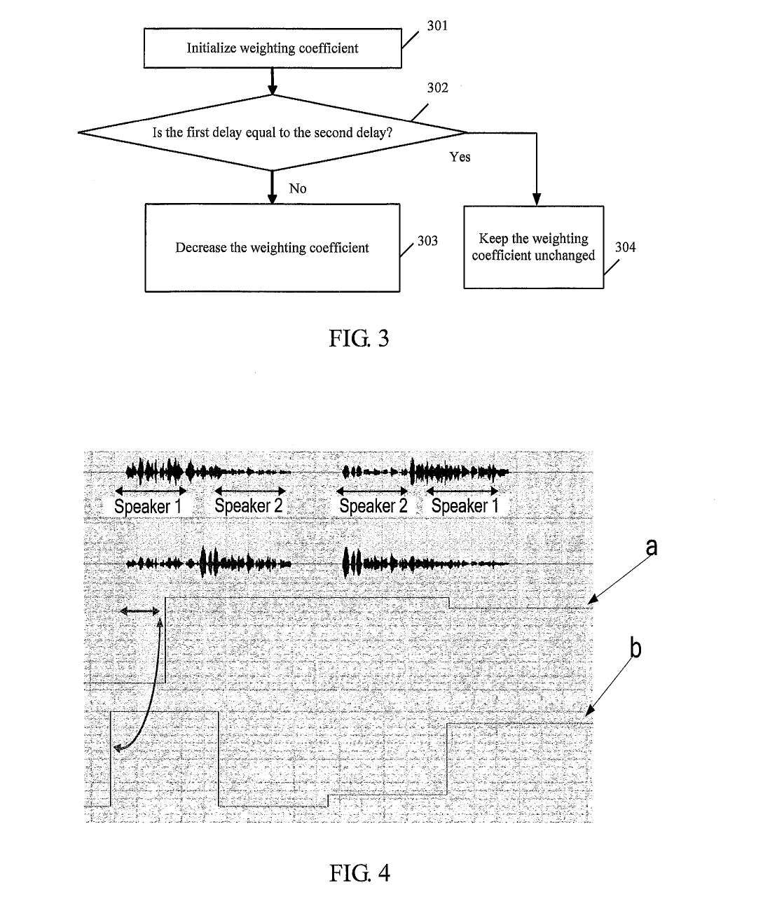

For details of the step, refer to the procedure shown in FIG. 3.

Step 204: Update the long-time cumulative cross-correlation function according to the weighting coefficient α2, determine the second delay corresponding to the long-time cumulative cross-correlation function, and determine the second delay as the delay between the left-channel signal and the right-channel signal.

The formula for calculating the long-time cumulative cross-correlation function has been described above. In the step, the long-time cumulative cross-correlation function is updated according to the weighting coefficient α2 to obtain different values of the long-time cumulative cross-correlation function. The greatest value or the greatest but one is selected among such values, the time corresponding to the selected value is determined as a second delay of the long-time cumulative cross-correlation function, and the second delay is determined as the delay between the left-channel signal and the right-channel signal. The initial value of the second delay may be obtained by means of calculating the long-time cumulative cross-correlation function after an initial value of the weighting coefficient α2 is set. The subsequent values of the second delay may be obtained by means of calculating, according to the adjusted weighting coefficient α2, the long-time cumulative cross-correlation function.

The second delay determined through the foregoing step can reflect the change of the signal delay from a positive value to a negative value or vice versa.

The determined second delay may be output for synchronization between the left-channel signal and the right-channel signal.

FIG. 3 is a flow chart of adjusting a weighting coefficient α2 according to a second embodiment of the present invention. The adjustment process includes the following steps:

Step 301: Initialize the weighting coefficient α2.

Initialize the weighting coefficient α2, for example, set the initial value as 1.

Step 302: Judge whether the first delay is equal to the second delay; if the first delay is equal to the second delay, proceed to step 304; if the first delay is not equal to the second delay, proceed to step 303.

In this step, it is judged whether the first delay is equal to the second delay according to the first delay and the second delay, and the subsequent step differs depending on the judgment result.

Step 303: Decrease the weighting coefficient α2.

In the step, the weighting coefficient α2 may be multiplied by an adjustment coefficient that is greater than 0 and less than 1. The adjustment coefficient is set empirically, or is selected according to the greatest value of the long-time cumulative cross-correlation function.

Step 304: Keep the weighting coefficient α2 unchanged.

FIG. 4 is a schematic diagram of a signal trace waveform for detecting a signal delay according to a second embodiment of the present invention.

As shown in FIG. 4, waveform a is a signal trace diagram in the prior art; waveform b is a signal trace diagram according to an embodiment of the present invention. When the speaker location changes from location 1 to location 2, namely, when sound field of the left-channel signal and the right-channel signal changes from one direction to another, the waveform shown in the waveform diagram changes in time. In this way, the location change of the speaker can be traced.

In the second embodiment of the present invention, the cumulative cross-correlation functions of the left-channel signal and the right-channel signal are categorized into short-time cumulative cross-correlation function and long-time cumulative cross-correlation function. The short-time cumulative cross-correlation function is obtained according to cross-correlation functions between channel signals; the first delay corresponding to the short-time cumulative cross-correlation function is determined; the long-time cumulative cross-correlation function is adjusted according to the relationship between the first delay and the second delay, where the second delay is obtained at the time of adjusting the long-time cumulative cross-correlation function; after the long-time cumulative cross-correlation function is adjusted, the second delay is determined as the delay detected between channel signals. The determined delay may reflect whether the delay between the channel signals changes from a positive value to a negative value or vice versa, and improves accuracy of the detected signal delay.

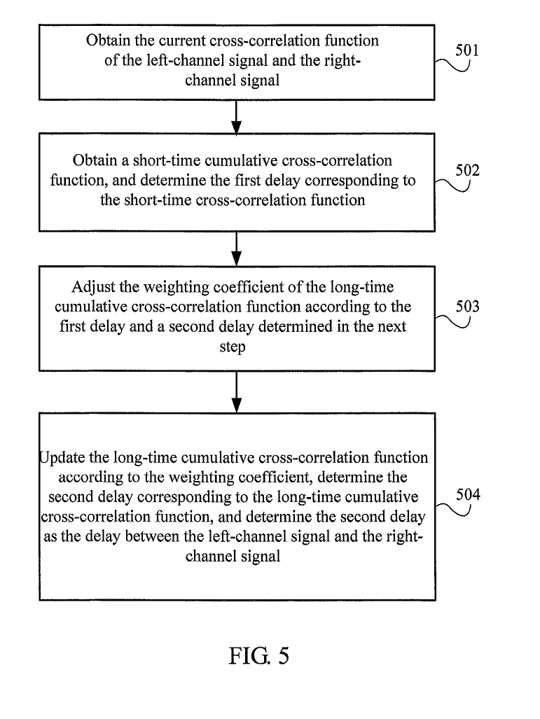

FIG. 5 is a flow chart of a method for detecting a signal delay according to a third embodiment of the present invention. The third embodiment differs from the second embodiment in that the process of adjusting the weighting coefficient α2 is different, and that sound field information is used as a reference.

As shown in FIG. 5, the method includes the following steps:

Step 501: Obtain the current cross-correlation function of the left-channel signal and the right-channel signal.

Step 502: Obtain a short-time cumulative cross-correlation function, and determine the first delay corresponding to the short-time cross-correlation function.

Steps 501-502 above are the same as steps 201-202 in the second embodiment.

Step 503: Adjust the weighting coefficient α2 of the long-time cumulative cross-correlation function according to the first delay and a second delay determined in the next step.

Step 504: Update the long-time cumulative cross-correlation function according to the weighting coefficient α2, determine the second delay corresponding to the long-time cumulative cross-correlation function, and determine the second delay as the delay between the left-channel signal and the right-channel signal.

This step is the same as step 204 in the second embodiment, and is not repeated herein.

The second delay determined through the foregoing step can reflect the change of the signal delay from a positive value to a negative value or vice versa.

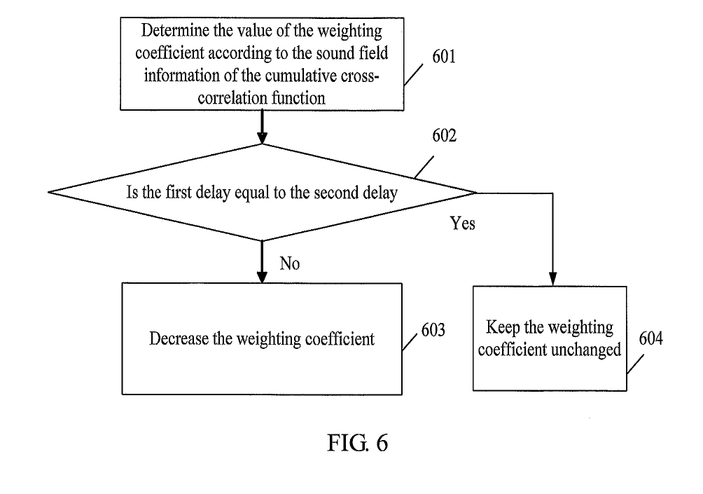

FIG. 6 is a flow chart of adjusting a weighting coefficient α2 according to a third embodiment of the present invention. The adjustment process includes the following steps:

Step 601: Determine the value of the weighting coefficient α2 according to sound field information of the cumulative cross-correlation function.

Unlike the corresponding step in the second embodiment, this step does not initialize the weighting coefficient α2, but calculates the value of the weighting coefficient α2 according to the sound field information of the cumulative cross-correlation function. An example of the cross-correlation function of the current frame is Ccf(n)−T<n<T,T>0.

The detailed process may be as follows:

(1) Calculate a ratio (cur_ratio) of a sum of current-frame cross-correlation functions with delay ≧0 to a sum of current-frame cross-correlation functions with delay ≦0.

$$cur\_ratio = {\sum }_{n = 0}^{T - 1} Ccf ( n ) / {\sum }_{n = - T + 1}^{0} Ccf ( n ) .$$

In this step, the cur_ratio is limited to a range such as <min, max>, where min and max are set empirically. Alternatively, min may be set to 0, and max may be set to an infinitely great value. The values of min and max are not limited in this embodiment. <min, max> is set to prevent too great or too small cur_ratio.

(2) Calculate a ratio (prev_ratio) of a sum of short-time cumulative cross-correlation functions with delay ≧0 to a sum of short-time cumulative cross-correlation functions with delay ≦0:

$$prev\_ratio = {\sum }_{n = 0}^{T - 1} ac\_Ccf ( n ) / {\sum }_{n = - T + 1}^{0} ac\_Ccf ( n ) ,$$

where the prev_ratio may be limited to a range <min,max> like the cur_ratio described above.

(3) Calculate the weighting coefficient α2 according to the calculated cur_ratio and prev_ratio.

For instance, the weighting coefficient α2 of the long-time cumulative cross-correlation function is calculated through: α2=|cur_ratio−prev_ratio|/k+b, but is not limited herein.

One method is as follows: k and b are constants. For example, in practice, a group of parameters for calculating the weighting coefficient is: min=0.5, max=1.5, k=−0.2, b=1, but is not limited herein.

It should be noted that the following is an alternative method:

(1) Calculate a difference of a sum of current-frame cross-correlation functions with delay ≧0 and a sum of current-frame cross-correlation functions with delay ≦0, where the difference is called a first difference.

(2) Calculate a difference of a sum of short-time cumulative cross-correlation functions with delay ≧0 and a sum of short-time cumulative cross-correlation functions with delay ≦0, where the difference is called a second difference.

(3) Calculate an absolute value of a difference between the first difference and the second difference to obtain a weighting coefficient α2 of the long-time cumulative cross-correlation function.

The weighting coefficient α2 of the long-time cumulative cross-correlation function may be calculated through, but without being limited to: α2=|first difference−second difference|/k+b, and may be calculated through other formulae.

Step 602: Judge whether the first delay is equal to the second delay; if the first delay is equal to the second delay, proceed to step 604; if the first delay is not equal to the second delay, proceed to step 603.

In this step, it is judged whether the first delay is equal to the second delay according to the first delay and the second delay, and the subsequent step differs depending on the judgment result

Step 603: Decrease the weighting coefficient α2 determined in step 601.

In this step, the weighting coefficient α2 determined in step 601 may be multiplied by an adjustment coefficient that is greater than 0 and less than 1. The adjustment coefficient is empirically set directly, or is selected according to the greatest value of the long-time cumulative cross-correlation function.

Step 604: Keep the weighting coefficient α2 unchanged.

The technical solution of the third embodiment brings the same effect as the technical solution of the second embodiment, and the sound field information of the cumulative cross-correlation function is also used as a reference.

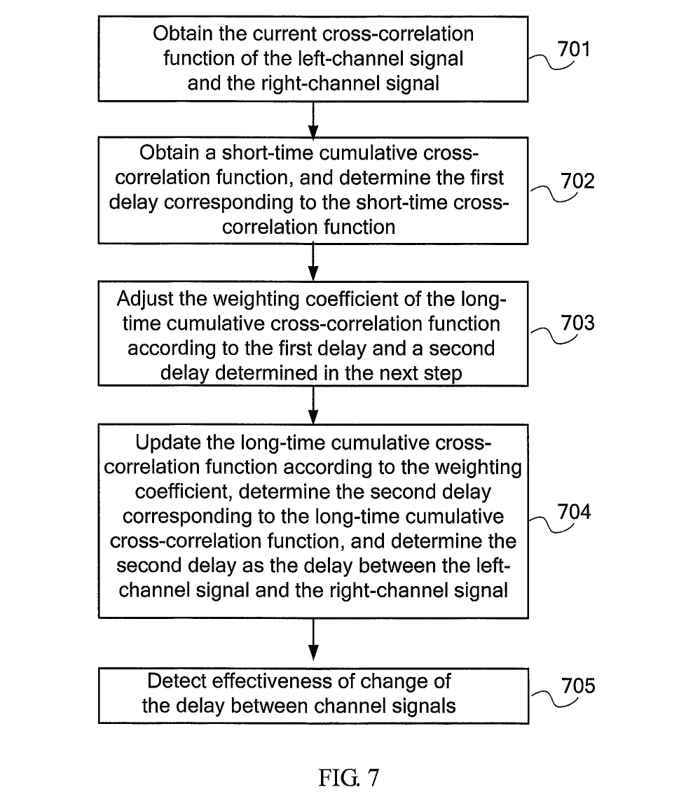

FIG. 7 is a flow chart of a method for detecting a signal delay according to a fourth embodiment of the present invention. Unlike the second embodiment, the fourth embodiment includes an additional step of detecting effectiveness of change of the delay between different channel signals.

As shown in FIG. 7, the method includes the following steps:

Steps 701-704 are the same as steps 201-204 in the second embodiment,

Step 705: Detect effectiveness of change of the delay between different channel signals.

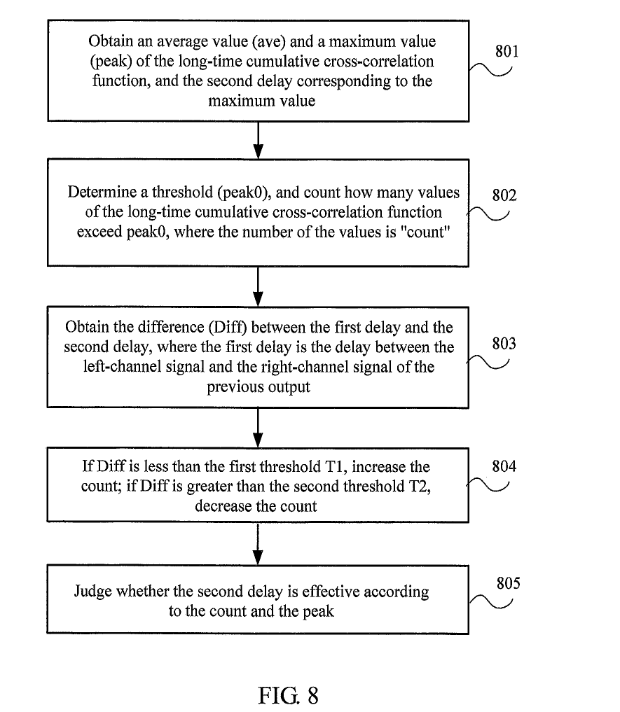

The details of this step are shown in FIG. 8. FIG. 8 is a flow chart of detecting effectiveness of change of a delay between different channel signals according to a fourth embodiment of the present invention. The detection process includes:

Step 801: Obtain an average value (ave) and a maximum value (peak) of the long-time cumulative cross-correlation function, and the second delay corresponding to the maximum value.

Step 802: Determine a threshold (peak0), and count how many values of the long-time cumulative cross-correlation function exceed peak0, where the number of the values is “count”.

Determine the threshold peak0 according to the average value (ave) and the maximum value (peak) of the long-time cumulative cross-correlation function, and then count how many values of the long-time cumulative cross-correlation function exceed peak0, where the number of the values is “count”.

Step 803: Obtain the difference (Diff) between the first delay and the second delay, where the first delay is the delay between the left-channel signal and the right-channel signal of the previous output.

Step 804: If Diff is less than a first threshold T1, increase the count by 1, for example; if Diff is greater than a second threshold T2, decrease the count by 1, for example.

Step 805: Judge whether the second delay is effective according to the count and the peak.

A first threshold related to the count and a second threshold related to the peak may be set. The first threshold and the second threshold may be empiric values. If the peak is greater than the second threshold and the count is less than the first threshold, the second delay is determined to be effective and stable, and can be output for subsequent synchronization between the left-channel signal and the right-channel signal.

It should be noted that the step shown in FIG. 8 may be added on the basis of the third embodiment.

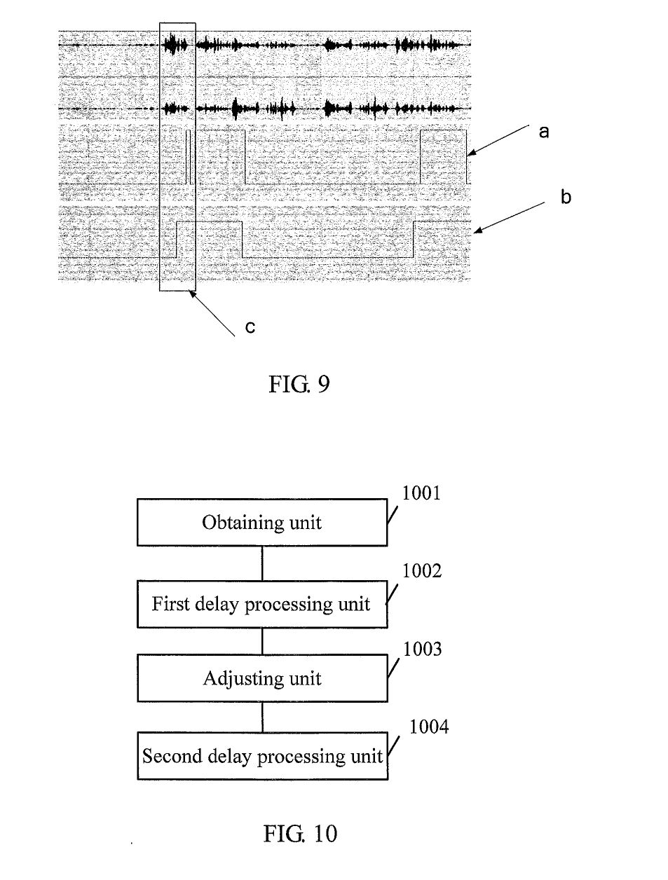

FIG. 9 is a schematic diagram of a signal trace waveform for detecting effectiveness of delay change according to a fourth embodiment of the present invention.

As shown in FIG. 9, waveform a is a signal trace diagram in the prior art; waveform b is a signal trace diagram according to an embodiment of the present invention. It is hard to judge whether the change of the delay between different channel signals is stable when waveform a is viewed from location c, but it is easy to determine that the change of the delay between different channel signals is stable when waveform b is viewed from location c.

According to the technical solution of the fourth embodiment, a difference (Diff) between the first delay and the second delay is obtained, where the first delay is the delay between the left-channel signal and the right-channel signal that are output previously; the Diff is compared with the first threshold and is compared with the second threshold, and the count is adjusted according to the comparison result. In this way, it is more accurate to judge whether the second delay is effective according to the count and the peak, and undue and unnecessary switching caused by output of instable delay is avoided.

The methods for detecting signal delay according to the embodiments of the present invention are described in detail above, and correspondingly, a detection apparatus and a coder are disclosed in an embodiment of the present invention.

FIG. 10 is a schematic diagram of a first structure of a detection apparatus according to an embodiment of the present invention.

As shown in FIG. 10, the detection apparatus includes an obtaining unit 1001, a first delay processing unit 1002, an adjusting unit 1003, and a second delay processing unit 1004. The obtaining unit 1001 is configured to obtain a first cumulative cross-correlation function according to cross-correlation functions between channel signals. The first delay processing unit 1002 is configured to determine a first delay between the channel signals corresponding to the first cumulative cross-correlation function. The adjusting unit 1003 is configured to adjust a second cumulative cross-correlation function according to a relationship between the first delay and a second delay that exist between the channel signals, where the second delay is obtained at time of adjusting the second cumulative cross-correlation function and an initial value of the second delay is determined according to an initial value of a second weighting coefficient of the second cumulative cross-correlation function. The second delay processing unit 1004 is configured to determine the second delay corresponding to the adjusted second cumulative cross-correlation function as a delay detected between the channel signals.

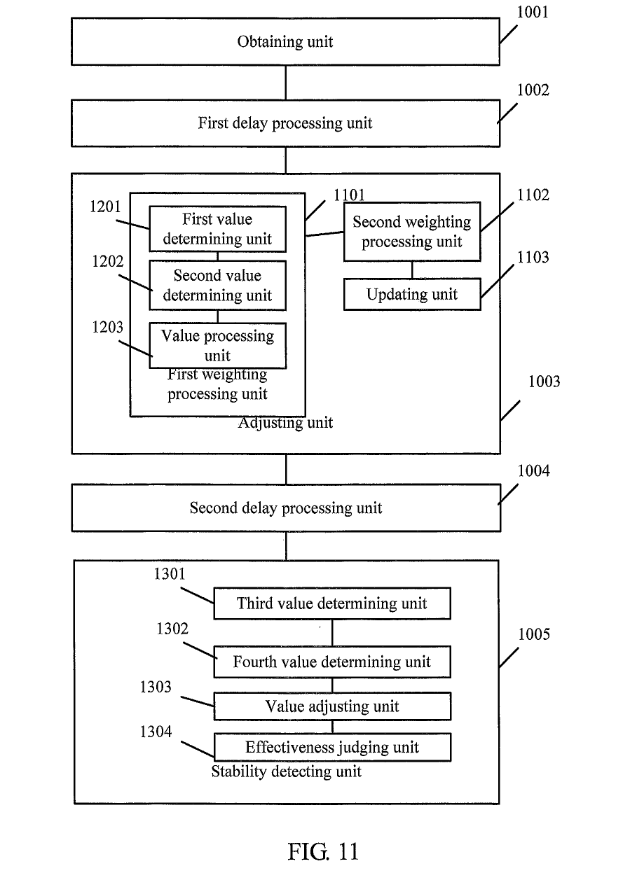

FIG. 11 is a schematic diagram of a second structure of a detection apparatus according to an embodiment of the present invention.

As shown in FIG. 11, the adjusting unit 1003 of the detection apparatus includes a first weighting processing unit 1101, a second weighting processing unit 1102, and an updating unit 1103. The first weighting processing unit 1101 is configured to obtain an initial value of a second weighting coefficient of a second cumulative cross-correlation function. The second weighting processing unit 1102 is configured to decrease the initial value of the second weighting coefficient to obtain a decreased value if it is determined that a first delay is not equal to a second delay between the channel signals. The updating unit 1103 is configured to update the second cumulative cross-correlation function according to the decreased value of the second weighting coefficient.

Alternatively, the first weighting processing unit 1101 is configured to set a value of a second weighting coefficient of a second cumulative cross-correlation function according to sound field information of a first cumulative cross-correlation function; the second weighting processing unit 1102 is configured to decrease the set value of the second weighting coefficient to obtain a decreased value if it is determined that a first delay is not equal to a second delay between the channel signals; and the updating unit 1103 is configured to update the second cumulative cross-correlation function according to the decreased value of the second weighting coefficient.

The first weighting processing unit 1101 may include a first value determining unit 1201, a second value determining unit 1202, and a value processing unit 1203. The first value determining unit 1201 is configured to determine a first value, where the first value is a ratio of a sum of current-frame cross-correlation functions with delay ≧0 to a sum of current-frame cross-correlation functions with delay ≦0, or is a difference between the sum of current-frame cross-correlation functions with delay ≧0 and the sum of current-frame cross-correlation functions with delay ≦0. The second value determining unit 1202 is configured to determine a second value, where the second value is a ratio of a sum of first cumulative cross-correlation functions with delay ≧0 to a sum of first cumulative cross-correlation functions with delay ≦0, or is a difference between the sum of first cumulative cross-correlation functions with delay ≧0 and the sum of first cumulative cross-correlation functions with delay ≦0. The value processing unit 1203 is configured to determine an absolute value of a difference between the first value and the second value as a value of the second weighting coefficient of the second cumulative cross-correlation function.

The detection apparatus may further include a stability detecting unit 1005.

The stability detecting unit 1005 may include a third value determining unit 1301, a fourth value determining unit 1302, a value adjusting unit 1303, and an effectiveness judging unit 1304. The third value determining unit 1301 is configured to determine a third value which measures how many values of the second cumulative cross-correlation function exceed the threshold. The fourth value determining unit 1302 is configured to determine a fourth value which is a difference between the first delay and the second delay, where the first delay is the delay between the output channel signals. The value adjusting unit 1303 is configured to adjust the third value according to a result of comparing the fourth value with the preset first threshold and the preset second threshold. The effectiveness judging unit 1304 is configured to determine effectiveness of the second delay according to a result of comparing the adjusted third threshold with the corresponding threshold and a result of comparing one of the values of the second cumulative cross-correlation function with the corresponding threshold.

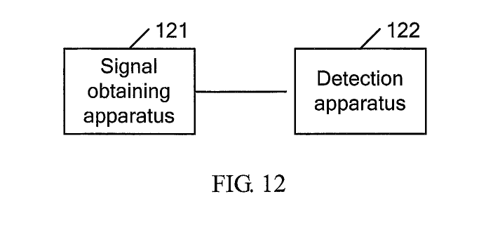

FIG. 12 is a schematic diagram of a structure of a coder according to an embodiment of the present invention.

As shown in FIG. 12, the coder includes a signal obtaining apparatus 121 and a detection apparatus 122. The signal obtaining apparatus 121 is configured to obtain channel signals; and the detection apparatus 122 is configured to: obtain a first cumulative cross-correlation function according to cross-correlation functions between channel signals; determine a first delay between the channel signals corresponding to the first cumulative cross-correlation function; adjust a second cumulative cross-correlation function according to a relationship between the first delay and a second delay that exist between the channel signals, where the second delay is obtained at time of adjusting the second cumulative cross-correlation function and an initial value of the second delay is determined according to an initial value of a second weighting coefficient of the second cumulative cross-correlation function; and determine the second delay corresponding to the adjusted second cumulative cross-correlation function as a delay detected between the channel signals.

The detection apparatus 122 has a structure shown in FIG. 10 or FIG. 11, and the structure has been described in detail above and is not repeated herein.

In conclusion, according to the technical solutions of the embodiments of the present invention, the first cumulative cross-correlation function is obtained according to cross-correlation functions between channel signals; the first delay between the channel signals corresponding to the first cumulative cross-correlation function is determined; the second cumulative cross-correlation function is adjusted according to the relationship between the first delay and the second delay that exist between the channel signals, where the second delay is obtained at the time of adjusting the second cumulative cross-correlation function and the initial value of the second delay is determined according to the initial value of the second weighting coefficient of the second cumulative cross-correlation function; and after the second cumulative cross-correlation function is adjusted, the second delay corresponding to the second cumulative cross-correlation function is determined as a delay detected between the channel signals. The determined delay can reflect whether the delay between the channel signals changes from a positive value to a negative value or vice versa, and improves accuracy of the detected signal delay.

Persons of ordinary skill in the art understand that all or part of the steps of the method in the embodiments of the present invention may be implemented by a program instructing relevant hardware. The program may be stored in computer readable storage media such as ROM/RAM, magnetic disk or CD-ROM.

A signal delay detection method, a detection apparatus, and a coder provided by the embodiments of the present invention are disclosed in detail above. Although the principle and the embodiments of the present invention are described through some exemplary embodiments, the above embodiments are only described for better understanding the method and core concept of the present invention. It is apparent that those skilled in the art can make modifications and variations to the embodiments and application scope of the present invention without departing from the spirit and scope of the invention. The invention is intended to cover the modifications and variations provided that they fall in the protection scope defined by the following claims or their equivalents.

What is claimed is:

1. A signal delay detection method, comprising:
obtaining a first cumulative cross-correlation function according to cross-correlation functions between channel signals;
determining a first delay between the channel signals corresponding to the first cumulative cross-correlation function;
adjusting a second cumulative cross-correlation function according to a relationship between the first delay and a second delay that exist between the channel signals, wherein the second delay is obtained at time of adjusting the second cumulative cross-correlation function and an initial value of the second delay is determined according to an initial value of a second weighting coefficient of the second cumulative cross-correlation function; and
determining the second delay corresponding to the adjusted second cumulative cross-correlation function as a delay detected between the channel signals.

2. The signal delay detection method according to claim 1, wherein:
the step of adjusting the second cumulative cross-correlation function according to the relationship between the first delay and the second delay comprises:
obtaining the initial value of the second weighting coefficient of the second cumulative cross-correlation function;
decreasing the initial value of the second weighting coefficient to obtain a decreased value if it is determined that the first delay is not equal to the second delay; and
updating the second cumulative cross-correlation function according to the decreased value of the second weighting coefficient.

3. The signal delay detection method according to claim 1, wherein:
the step of adjusting the second cumulative cross-correlation function according to the relationship between the first delay and the second delay comprises:
setting a value of the second weighting coefficient of the second cumulative cross-correlation function according to sound field information of the first cumulative cross-correlation function;
decreasing the set value of second weighting coefficient to obtain a decreased value if it is determined that the first delay is not equal to the second delay; and
updating the second cumulative cross-correlation function according to the decreased value of the second weighting coefficient.

4. The signal delay detection method according to claim 3, wherein:
the step of setting the value of the second weighting coefficient of the second cumulative cross-correlation function according to the sound field information of the first cumulative cross-correlation function comprises:
determining a first value, wherein the first value is a ratio of a sum of current-frame cross-correlation functions with delay ≧0 and a sum of current-frame cross-correlation functions with delay ≦0, or is a difference between the sum of current-frame cross-correlation functions with delay ≧0 and the sum of current-frame cross-correlation functions with delay ≦0;
determining a second value, wherein the second value is a ratio of a sum of first cumulative cross-correlation functions with delay ≧0 and a sum of first cumulative cross-correlation functions with delay ≦0, or is a difference between the sum of first cumulative cross-correlation functions with delay ≧0 and the sum of first cumulative cross-correlation functions with delay ≦0; and
determining an absolute value of a difference between the first value and the second value as a value of the second weighting coefficient of the second cumulative cross-correlation function.

5. The signal delay detection method according to claim 2, wherein:
the step of decreasing is: multiplying the weighting coefficient by an adjustment coefficient that is greater than 0 and less than 1.

6. The signal delay detection method according to claim 1, wherein:
after determining the second delay corresponding to the adjusted second cumulative cross-correlation function as the detected delay, the method further comprises:
determining a third value which measures how many values of the second cumulative cross-correlation function exceed the threshold;
determining a fourth value which is a difference between the first delay and the second delay, wherein the first delay is a delay between output channel signals;
adjusting the third value according to a result of comparing the fourth value with a preset first threshold and a preset second threshold; and
determining effectiveness of the second delay according to a result of comparing the adjusted third threshold with a corresponding threshold and a result of comparing one of values of the second cumulative cross-correlation function with a corresponding threshold.

7. The signal delay detection method according to claim 1, wherein:
the first cumulative cross-correlation function is a short-time cumulative cross-correlation function, and the second cumulative cross-correlation function is a long-time cumulative cross-correlation function.

8. A detection apparatus, comprising:
an obtaining unit, configured to obtain a first cumulative cross-correlation function according to cross-correlation functions between channel signals;
a first delay processing unit, configured to determine a first delay between the channel signals corresponding to the first cumulative cross-correlation function;
an adjusting unit, configured to adjust a second cumulative cross-correlation function according to a relationship between the first delay and a second delay that exist between the channel signals, wherein the second delay is obtained at time of adjusting the second cumulative cross-correlation function and an initial value of the second delay is determined according to an initial value of a second weighting coefficient of the second cumulative cross-correlation function; and
a second delay processing unit, configured to determine the second delay corresponding to the adjusted second cumulative cross-correlation function as a delay detected between the channel signals.

9. The detection apparatus according to claim 8, wherein the adjusting unit comprises:
a first weighting processing unit, configured to obtain an initial value of the second weighting coefficient of the second cumulative cross-correlation function;
a second weighting processing unit, configured to decrease the initial value of the second weighting coefficient to obtain a decreased value if it is determined that the first delay is not equal to the second delay between the channel signals; and
an updating unit, configured to update the second cumulative cross-correlation function according to the decreased value of the second weighting coefficient.

10. The detection apparatus according to claim 8, wherein the adjusting unit comprises:
a first weighting processing unit, configured to set a value of the second weighting coefficient of the second cumulative cross-correlation function according to sound field information of the first cumulative cross-correlation function;
a second weighting processing unit, configured to decrease the set value of the second weighting coefficient to obtain a decreased value if it is determined that the first delay is not equal to the second delay between the channel signals; and
an updating unit, configured to update the second cumulative cross-correlation function according to the decreased value of the second weighting coefficient.

11. The detection apparatus according to claim 10, wherein the first weighting processing unit comprises:
a first value determining unit, configured to determine a first value, wherein the first value is a ratio of a sum of current-frame cross-correlation functions with delay ≧0 to a sum of current-frame cross-correlation functions with delay ≦0, or is a difference between the sum of current-frame cross-correlation functions with delay ≧0 and the sum of current-frame cross-correlation functions with delay ≦0;
a second value determining unit, configured to determine a second value, wherein the second value is a ratio of a sum of first cumulative cross-correlation functions with delay ≧0 to a sum of first cumulative cross-correlation functions with delay ≦0, or is a difference between the sum of first cumulative cross-correlation functions with delay ≧0 and the sum of first cumulative cross-correlation functions with delay ≧0; and
a value processing unit, configured to determine an absolute value of a difference between the first value and the second value as a value of the second weighting coefficient of the second cumulative cross-correlation function.

12. The detection apparatus according to claim 8, further comprising:
a third value determining unit, configured to determine a third value which measures how many values of the second cumulative cross-correlation function exceed the threshold;
a fourth value determining unit, configured to determine a fourth value which is a difference between the first delay and the second delay, wherein the first delay is a delay between the output channel signals;
a value adjusting unit, configured to adjust the third value according to a result of comparing the fourth value with a preset first threshold and a preset second threshold; and
an effectiveness judging unit, configured to determine effectiveness of the second delay according to a result of comparing the adjusted third threshold with a corresponding threshold and a result of comparing one of values of the second cumulative cross-correlation function with a corresponding threshold.

13. A coder, comprising:
a signal obtaining apparatus, configured to obtain channel signals; and
a detection apparatus, configured to: obtain a first cumulative cross-correlation function according to cross-correlation functions between channel signals; determine a first delay between the channel signals corresponding to the first cumulative cross-correlation function; adjust a second cumulative cross-correlation function according to a relationship between the first delay and a second delay that exist between the channel signals, wherein the second delay is obtained at time of adjusting the second cumulative cross-correlation function and an initial value of the second delay is determined according to an initial value of a second weighting coefficient of the second cumulative cross-correlation function; and determine the second delay corresponding to the adjusted second cumulative cross-correlation function as a delay detected between the channel signals.

14. A computer readable storage medium, comprising computer program codes that cause the compute processor to execute the following steps when executed by a computer processor:
obtaining a first cumulative cross-correlation function according to cross-correlation functions between channel signals;
determining a first delay between the channel signals corresponding to the first cumulative cross-correlation function;
adjusting a second cumulative cross-correlation function according to a relationship between the first delay and a second delay that exist between the channel signals, wherein the second delay is obtained at time of adjusting the second cumulative cross-correlation function and an initial value of the second delay is determined according to an initial value of a second weighting coefficient of the second cumulative cross-correlation function; and
determining the second delay corresponding to the adjusted second cumulative cross-correlation function as a delay detected between the channel signals.
